(19) United States
(12) Patent Application Publication
(10) Pub. No.: US 2024/0362360 A1
(43) Pub. Date: Oct. 31, 2024

(54) GREEDY LOOKAHEAD K-ANONYMITY FOR SMB SEARCH

(71) Applicant: INTUIT INC., Mountain View, CA (US)

(72) Inventors: Natalie BARELIYAHU, Tel Aviv (IL); Hadar LACKRITZ, Tel Aviv (IL); Omer WOSNER, Tel Aviv (IL); Yair HORESH, Tel Aviv (IL); Sigalit BECHLER, Tel Aviv (IL)

(73) Assignee: INTUIT INC., Mountain View, CA (US)

(21) Appl. No.: 18/308,478

(22) Filed: Apr. 27, 2023

(51) Int. Cl. G06F 21/62

(52) U.S. Cl. CPC G06F 21/6245

(57) ABSTRACT

A system and method implementing K-anonymity processing of a data record to protect sensitive information, while still revealing useful information. The system and method performing K-anonymity processing of categories in the data record, and choosing to mask the data of the category that produces the highest anonymity score. The system and method repeats the process until a K-value of the data record is achieved.

### BACKGROUND

Some conventional software applications are known to provide a service where an end user is able to search for information in a data record. This searchable information may include sensitive (e.g., personal) information of searchable entities (e.g., persons, companies, etc.). In order to protect the privacy of the searchable entities, these conventional systems perform static rule-based masking of searchable information where certain portions of the searchable information are masked (e.g., hidden, modified, suppressed, etc.), while other portions are revealed in their original form. These static rule-based masking solutions are deficient because they are not reconfigurable and sometimes reveal too much or too little of the searchable entity information-all of which are undesirable.

### SUMMARY

Embodiments disclosed herein solve the aforementioned technical problems and may provide other technical solutions as well. Contrary to conventional techniques that implement static rule-based masking techniques, one or more embodiments disclosed herein implement intelligent K-anonymity masking processing.

An example embodiment includes a method performed by a processor. The method may comprise determining or receiving a K-value indicating a level of anonymity for entries in a data record, determining a masking function for masking the entries in the data record, and applying the masking function to the entries in the data record to modify the data record to produce a masked data record having the K-value.

Another example embodiment includes a system. The system may comprise a non-transitory storage medium storing computer program instructions, and one or more processors configured to execute the computer program instructions to cause operations to be performed. The operations may comprise determining or receiving a K-value indicating a level of anonymity for entries in a data record, determining a masking function for masking the entries in the data record, and applying the masking function to the entries in the data record to modify the data record to produce a masked data record having the K-value.

### BRIEF DESCRIPTION OF THE DRAWINGS

FIG. 1 shows an example method of K-anonymity processing, based on the principles disclosed herein.

FIG. 2 shows an example method of K-anonymity processing for different data types, based on the principles disclosed herein.

FIG. 3 shows an example method of selecting a K-value for K-anonymity processing, based on the principles disclosed herein.

FIG. 4 shows an example method of column-based K-anonymity processing, based on the principles disclosed herein.

FIG. 5 shows an example use case of K-anonymity processing, based on the principles disclosed herein.

FIG. 6 shows an example of a system of computing devices that implement various features and processes of the K-anonymity processing, based on the principles disclosed herein.

FIG. 7 shows a block diagram of an example computing device that implements various features and processes of the K-anonymity processing, based on the principles disclosed herein.

### DETAILED DESCRIPTION OF SEVERAL EMBODIMENTS

To mitigate the above deficiencies, embodiments disclosed herein leverage K-anonymity processing of data to protect sensitive information, while still revealing useful information.

For example, a data provider (e.g., software application) may have a stored data record of information relating to searchable entities (e.g., persons). In this example, the data record may include categories such as the name, age, sex, address, and/or education of searchable persons. An end user of the software application may want to access the information from data provider servers via the server message block (SMB) protocol or the like. The end user, for example, may be a marketing company, research firm, customer or the like. The data provider has competing goals in providing the requested information. Specifically, the data provider has to provide enough information to the end user such that the data is useful to the end user (e.g., for research, marketing, etc.), while still providing adequate privacy protection of the data entities, thereby ensuring that specific persons cannot be identified by entries in the data record. To accomplish these competing goals, the disclosed system and methods determine a privacy value which is referred to herein as a “K-value”, determine identifying data categories of the data record, and modify the data belonging to the identified data categories via masking techniques such as grouping, clustering, character subtraction and other methods. The resultant modified data record reveals useful information to the end user, while also masking sensitive information to a level indicated by the determined K-value. It is noted that as the K-value increases, data privacy increases while the data usefulness decreases. Conversely, as the K-value decreases, data privacy decreases while the data usefulness increases. In other words, a larger K-value makes it more difficult for a bad actor to attack (e.g., de-anonymize) the data to identify specific entities in the data record.

In one example, the K-value represents a number “K” of duplicate entries for a specific category in the data record or for the entire data record. For example, a K-value of 2 may be chosen to ensure that there are at least 2 duplicate entries (2-anonymity) for data of a given category. In the example described above, this may be achieved, for example, by identifying the name, age and address categories of the searchable entities as potential “identifiers” (values likely to reveal the identities of the searchable entities) that should be masked (e.g., hidden, modified, etc.) in some manner. For example, the K-anonymity processing may include masking the data such that the searchable entities names are partially or fully removed from the record to avoid disclosing their true identity, grouping the ages of the searchable entities into age ranges to avoid disclosing exact ages, and broadening the addresses of the searchable entities into cities to avoid disclosing specific home addresses.

In the example described above, the sex and education categories may be determined to be “non-identifiers” (values less likely to reveal the identities of the searchable entities) and therefore are not modified by the masking. The “likeliness” of revealing the identities of the searchable entities may be based on quantitative techniques (e.g., X % chance of revealing the identities of the searchable entities, etc.), or qualitative techniques (e.g., selected categories based on experience, trial and error, etc.). In this example, the resultant modified data record (e.g., masked data record) may include at least 2 duplicate entries with respect to each of the entries in the name, age and address categories. The sex and education categories may be unmodified since they are considered non-identifiers. The end user (e.g., marketing firm, etc.) can then use the resultant modified data record to determine correlations between education as related to a person's age range, sex and general geographic location.

The figures herein are described with respect to disclosed system and methods of providing K-anonymity processing. A specific example with respect to K-anonymity processing of personal information is described herein. However, it is noted that the disclosed system and methods are applicable to K-anonymity processing of any data set that requires processing of data to protect sensitive information, while still revealing useful information to the end user.

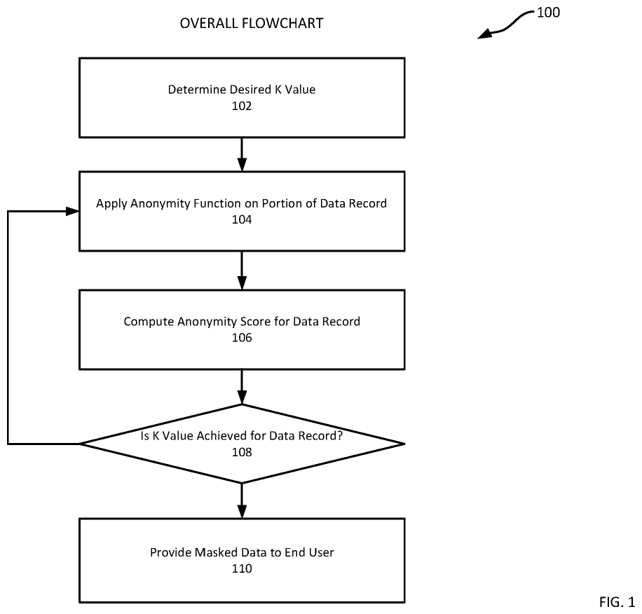

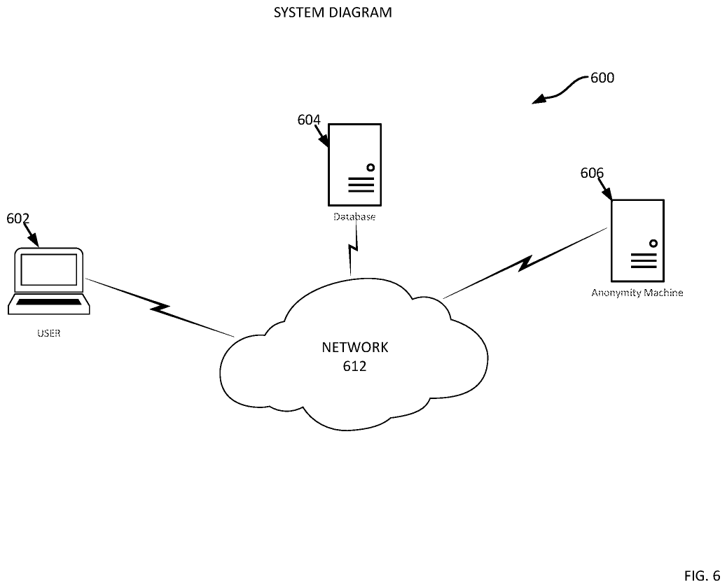

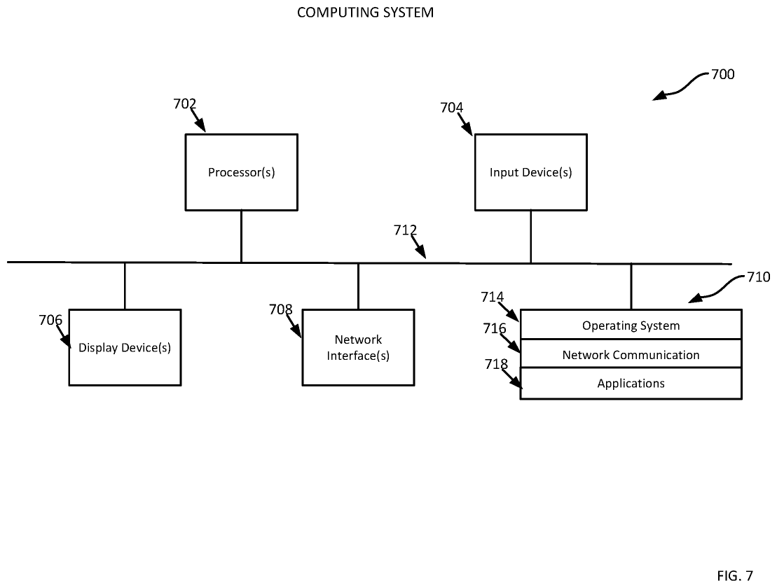

The above-described features are now described in detail with respect to FIGS. 1-7. Specifically, FIGS. 1-5 are flowcharts describing the example methods performed by the disclosed system, and FIGS. 6 and 7 show the example hardware for implementing the disclosed system.

FIG. 1 shows an example method 100 performed by the disclosed system to provide K-anonymity processing, based on the principles disclosed herein. In step 102, the method determines a desired K-value for the data record. In one example, the K-value (number of duplicate entries to produce) may be determined quantitatively by determining an acceptable probability of a bad actor successfully identifying the searchable entities in the data record. For example, the disclosed system may determine based on the data type, data importance, data usage and other factors, that an acceptable probability of a bad actor successfully identifying the searchable entities is less than X % (e.g., 10%). In this example, the disclosed system may determine based on various factors including the number of entries in the data record, the number of categories per data entry, the type of data and other factors that a specific K-value (e.g., K=4) is to be utilized to achieve the desired probability. In other words, in this example, the data record is to be processed such that each data entry has at least K−1 (e.g. 3) other duplicate data entries that are indistinguishable from one another.

It is noted that the K-value may be determined for all the categories of the data entries in the data record, or for select categories. For example, if each data entry includes 5 categories of data, all 5 data categories may be processed for duplication. In another example, only 3 of the 5 categories may be processed for duplication. The decision of whether to process all the categories or a subset of the categories is based on the determination of identifier and non-identifier categories. As mentioned above, identifier categories are categories of data (e.g., personal name of entity, etc.) that may be more likely to be used by the bad actor to identify the entity, whereas non-identifier categories are categories of data (e.g., State of residence) that may be less likely to be used by the bad actor to identify the entity.

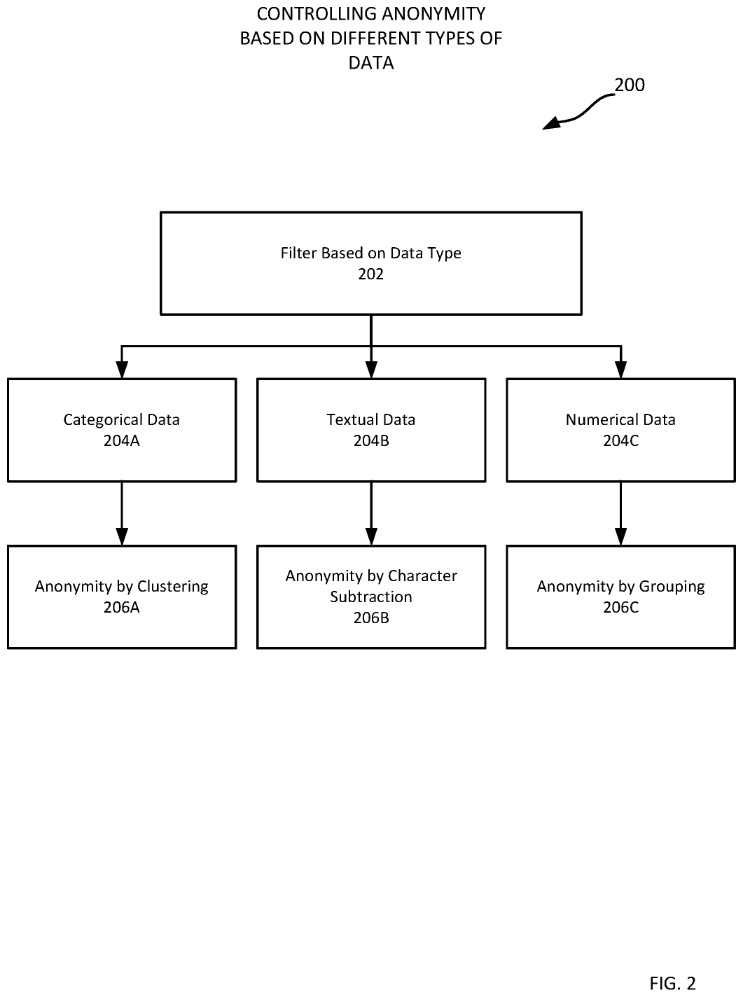

Once the K-value is determined, the method applies the K-anonymity processing to a portion of the data record in step 104. For example, the K-anonymity processing may be applied to a first category of data in the data record to ensure that each entry within the respective category has K−1 duplicate entries. The K-anonymity processing is a masking function that may include hiding certain characters, grouping certain data as well as other masking methods. For example, if the first category includes the personal names of the searchable entities, all or part of these names may be modified or hidden. Further details of the K-anonymity processing for producing the duplicates are described below with reference to FIGS. 2-5.

After applying K-anonymity processing, the disclosed system computes the anonymity score in step 106. The score may be computed across all categories or selected identifier categories as mentioned above. In other words, once a category is masked during the K-anonymity processing, the disclosed system determines the K-value of the data record. If it is determined in step 108 that the desired K-value is achieved, then the application provides the modified (e.g., masked) data to the end user in step 110. If it is determined in step 108 that the desired K-value is not achieved over the data record, then the application repeats step 104 by applying the K-anonymity processing to the same category but to a different (e.g., more restrictive) degree (e.g., additional masking of the already masked data), or by applying the K-anonymity processing to another category of the data record. Choosing whether to apply the K-anonymity processing to the same category or to a different category may be based on analysis of what masking choice would best contribute to achieving the desired K-value. In other words, each time through the loop, the disclosed system and method may determine how masking would affect each category and the overall K-value, and choose to implement the masking that offers the best results. This overall process is repeated until the K-value of the data record is achieved. In other words, the K-anonymity processing modifies the data record category by category until the desired K-value is achieved for the data record.

It is noted that although the data is masked and made available to the end user, the original data record (e.g., data record prior to K-anonymity processing) is stored by the disclosed system as a backup copy. In other words, the modified data set is for the end user, but the original data record is still stored in the backend of the disclosed system (e.g., stored in the server).

As mentioned above, K-anonymity processing performs masking functions where the data is modified in some manner to anonymize the data. The type of masking function used may be based on various factors including but not limited to the type of data. For example, numerical data, textual data and categorical data may be masked using different techniques. FIG. 2 shows an example method 200 performed by the disclosed system to provide K-anonymity processing for different data types, based on the principles disclosed herein. As shown in step 202, the method filters the data based on data type. In other words, the type of data in each identifier category is determined by the disclosed system. In one example, categorical data, textual data and numerical data are filtered separately in steps 204A, 204B and 204C for separate K-anonymity processing. In steps 206A, 206B and 206C, the categorical data, textual data and numerical data are respectively processed according to different masking techniques including but not limited to clustering, character subtraction and grouping.

The method 200 may be explained further with reference to the example described above, where the data record includes personal names, ages and home addresses for searchable entities. K-anonymity processing to achieve a desired K-value may be achieved by clustering the home addresses into larger clusters (e.g., use the states of residence rather than street addresses), subtracting characters from the name (e.g., mask a portion of the name or the entire name with symbols such as asterisks), and grouping the ages (e.g., use age ranges rather than exact ages). By performing clustering, subtraction and grouping, the disclosed system produces a data record where each entry has K-duplicate entries within the same data record.

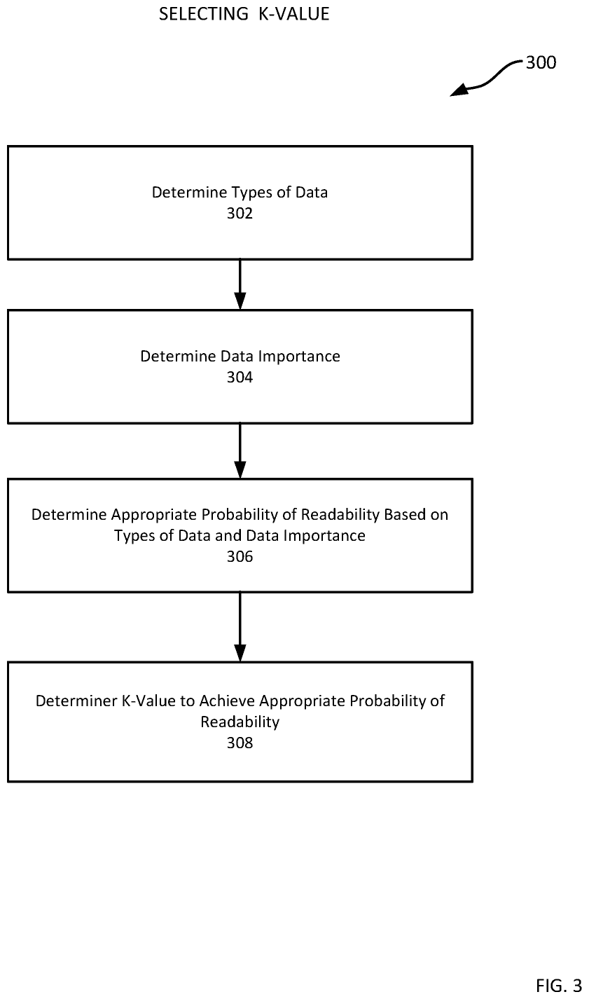

As mentioned above, the disclosed system determines a K-value for achieving a threshold level of security as a result of the K-anonymity processing. FIG. 3 shows an example method 300 performed by the disclosed system for selecting the K-value for the K-anonymity processing, based on the principles disclosed herein. In step 302, the method determines the type of data in the data record (e.g., name, address, age, sex, etc.). In step 304, the disclosed system then determines the importance of this data. The importance may be based on the usefulness of the data to the end user and to the bad actor. In other words, the data entry may be useful to some degree to the end user to use for righteous purposes, but may also be useful to some degree to the bad actor to use for nefarious purposes (e.g., steal personal information). The data may therefore be assigned one or more numerical values for importance to the end user and/or the bad actor. The disclosed system can use the type of data and the measure of data importance to determine an appropriate probability of readability in step 306. For example, if the data has low importance to the end user and high importance to the bad actor, then the disclosed system can assign a low probability of readability to the data at which point the data can be more significantly masked. Conversely if the data has high importance to the end user and low importance to the bad actor, then the disclosed system can assign a high probability of readability to the data at which point the data can receive little to no masking. Of course, if the data has high importance to the end user and high importance to the bad actor, then the disclosed system can assign a probability of readability to the data that takes into consideration these competing interests. In either case, in step 308, the disclosed system determines a K-value that is appropriate for achieving the probability of readability.

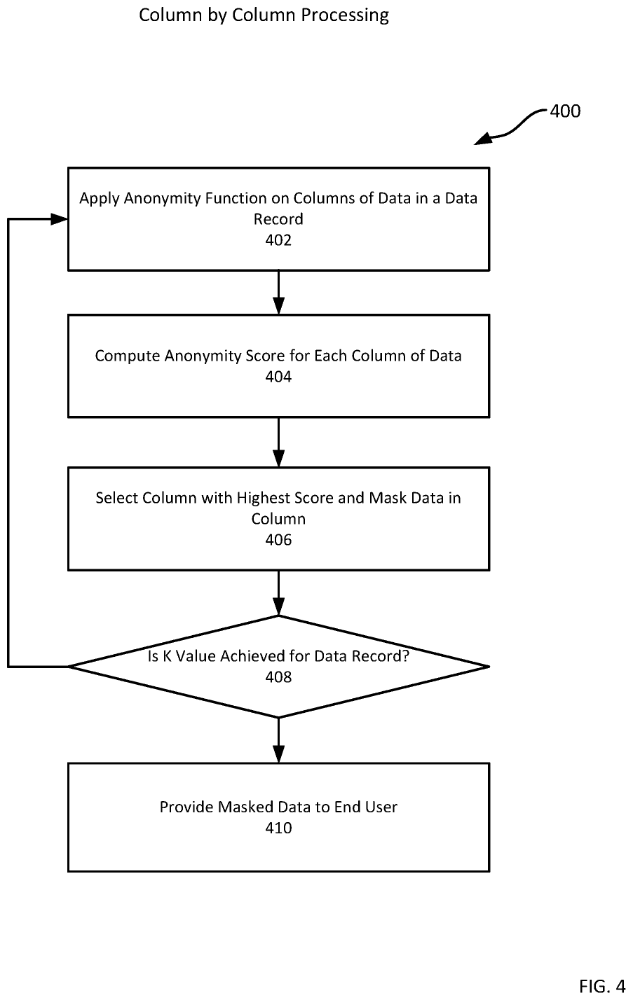

As mentioned above, K-anonymity processing may be performed (e.g., sequentially) for different portions of a data record. These portions may be columns and/or rows in a table of the data record. FIG. 4 shows an example method 400 performed by the disclosed system to provide column-based K-anonymity processing, based on the principles disclosed herein. In step 402, the disclosed system applies the K-anonymity processing to the chosen columns. This K-anonymity processing results in anonymity scores (e.g., K-values) for each of the chosen columns for the specific masking techniques. After the columns are processed, the disclosed system computes the anonymity scores for each column in step 404 and implements a greedy solution in step 406 by selecting the column with the highest K-value (e.g., column that if masked will contribute most to K-value of the data record) and then masking the selected column. In other words, the chosen column is masked, and the unchosen columns are left unmasked for the next iteration of the process. The disclosed system then measures the K-value for the data record in step 408. If it is determined that the K-value for the data record is achieved in step 408, the disclosed system provides the masked data to the end user. If it is determined that the K-value for the data record is not achieved in step 408, the disclosed system repeats the process in step 402 until the K-value for the data record is achieved. In other words, the disclosed system applies K-anonymity processing to all the chosen columns, determines the anonymity scores of the columns and sequentially greedily selects the column with the largest effect on the K-value for the data record. In this manner the data record is masked one column at a time until the K-value for the data record is achieved. It is noted that even as columns are masked through each iteration of the process, the disclosed system and method still apply anonymity processing to these masked columns along with the unmasked columns. The anonymity processing applied to the masked columns may be used as additional masking to achieve a higher anonymity score. For example, if during the first iteration, the data in the name column is grouped into age ranges to provide a higher anonymity score, then during the second iteration, the data in the name column can be grouped yet again into larger age ranges to provide an even higher anonymity score.

It is noted that, K-anonymity processing can be applied using other techniques, and therefore is not limited to column-by-column sequential processing. For example, the data may be processed row-by-row, the columns and/or rows may be processed simultaneously, or the data may be processed by each entry regardless of the columns or rows.

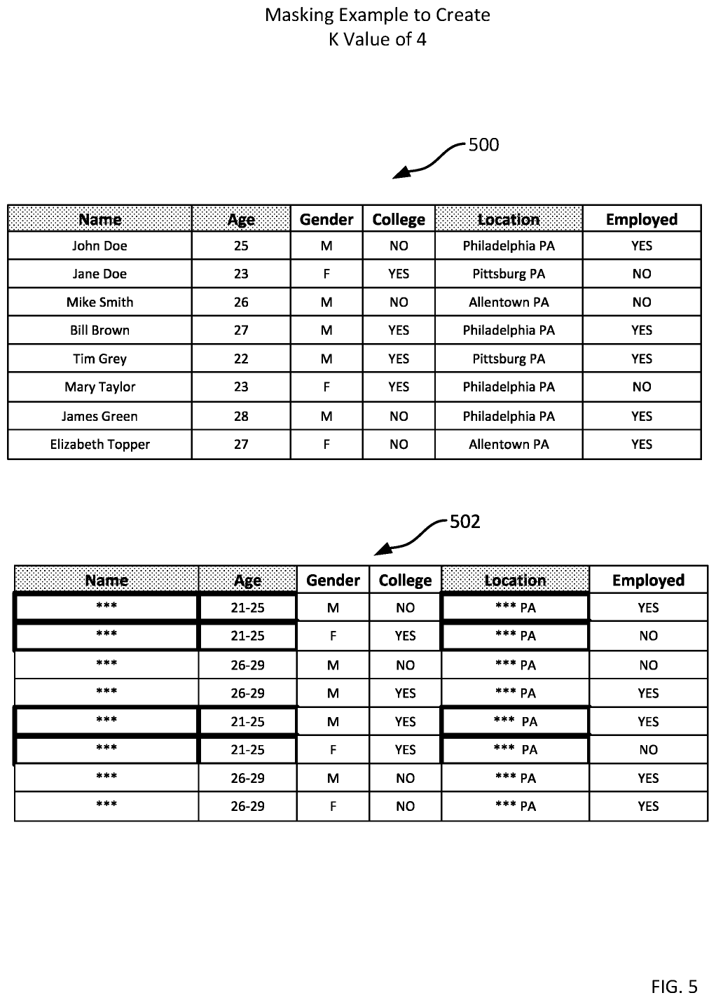

FIG. 5 shows tables 500 and 502 to illustrate an example use case of K-anonymity processing, based on the principles disclosed herein. Table 500 is a data record including 8 entries of searchable entities (e.g., persons) that may be useful to an end user interested in how college degrees and gender effect employment. Each entry in this example includes the data categories of name, age, gender, college degree status, location and current employment status. In this example, the disclosed system may determine a desired K-value for the data record by analyzing the importance of the data to the end user and the bad actor. For example, the end user is primarily interested in gender, college degree status and employment status information, whereas the bad actor may be primarily interested in name, age and location information. The disclosed system may determine that a K-value of 4 is desirable to ensure that every entry has at least 3 duplicate entries with respect to the risky categories (name, age and location).

Once the desired K-value is determined, the disclosed system may begin the K-anonymity processing. For example, the disclosed system may apply K-anonymity processing such that the names are completely masked, the ages are grouped into age categories and the locations are clustered into larger geographical areas such as the state. Results for 4-anonymity processing of the data record 500 is shown in table 502 where the 4 boxed entries are duplicates with respect to name, age and location, and the 4 un-boxed entries are also duplicates with respect to name, age and location. In other words, each of the individual persons listed in table 500 is now grouped with and indistinguishable from 3 other persons in the table to form 4 duplicate entries, which makes it difficult for a bad actor to identify any one individual from the table, while simultaneously allowing the end user to interpret important information relevant to their research regarding college degree status, gender and employment status.

Other use cases are of course possible. For example, in one use case, the data provider may allow the end users to access information of business entities (e.g., potential business customers, partnerships, etc.). In this example, the disclosed system may determine categories (e.g., email addresses, phone numbers, etc.) of the information of the business entities for masking in K-anonymity processing, while determining other categories (e.g., business name, business address, etc.) that do not require masking. The modified data record may therefore allow the end user to identify business entities by names and addresses, while protecting the contact information of the business entities from bad actors that may, for example, sell contact information to Spammers. To unmask the contact information, the end user can send a connection request to the business entities. If the business entities agree to connect to the end user, then the masked contact information may be revealed to the end user.

Again, it is noted that the methods described in FIGS. 1-5 can be performed for K-anonymity processing of a data record to achieve usability by the end user while also achieving a specified level of security for protecting against data usage by a bad actor. In other words, the disclosed system provides a method to intelligently provide data masking that can be tailored to specific systems and data records.

FIG. 6 shows an example of a system 600 configured for providing K-anonymity processing of a data record. It should be understood that the components of the system 600 shown in FIG. 6 and described herein are merely examples and systems with additional, alternative, or fewer number of components should be considered within the scope of this disclosure.

As shown, the system 600 comprises at least one end user device 602 and two servers 604 and 606 interconnected through a network 612. Server 604 supports operation of the data record databases and the software application that allows the end user to access the data record, while server 606 supports operation of the K-anonymity processing application for processing the data record. In the illustrated example, user device 602 is a PC but could be any device (e.g., smartphone, tablet, etc.) providing access to the servers via network 612. User device 602 has a user interface UI, which may be used to communicate with the servers using the network 612 via a browser or via software applications. The network 612 may be the Internet and or other public or private networks or combinations thereof. The network 612 therefore should be understood to include any type of circuit switching network, packet switching network, or a combination thereof. Non-limiting examples of the network 612 may include a local area network (LAN), metropolitan area network (MAN), wide area network (WAN), and the like.

In an example, end user device 602 may communicate with server 604 to utilize a data provider software application for retrieving data from the data record database. The software application may connect database server 604 with anonymity machine server 606, such that anonymity machine server 606 performs the K-anonymity processing described above with respect to FIGS. 1-5 to anonymize the data prior to sending the data to user device 602.

Servers 604 and 606 and user device 602 are each depicted as single devices for ease of illustration, but those of ordinary skill in the art will appreciate that servers 604 and 606 and user device 602 may be embodied in different forms for different implementations. For example, any or each of the servers may include a plurality of servers including a plurality of databases, etc. Alternatively, the operations performed by any of the servers may be performed on fewer (e.g., one or two) servers. In another example, a plurality of user devices (not shown) may communicate with the servers. Furthermore, a single user may have multiple user devices (not shown), and/or there may be multiple users (not shown) each having their own respective user devices (not shown). Regardless, the hardware configuration shown in FIG. 6 may be a system that supports the functionality of the K-anonymity processing shown in FIGS. 1-5.

FIG. 7 shows a block diagram of an example computing device 700 that is configured for facilitating the K-anonymity processing based on the principles disclosed herein. For example, computing device 700 may function as the servers 604 and 606 and/or user device 602, or a portion or combination thereof in some embodiments. The computing device 700 performs one or more steps of the methods shown in FIGS. 1-5. The computing device 700 is implemented on any electronic device that runs software applications derived from compiled instructions, including without limitation personal computers, servers, smart phones, media players, electronic tablets, game consoles, email devices, etc. In some implementations, the computing device 700 includes one or more processors 702, one or more input devices 704, one or more display devices 706, one or more network interfaces 708, and one or more computer-readable media 710. Each of these components is coupled by a bus 712.

Display device 706 includes any display technology, including but not limited to display devices using Liquid Crystal Display (LCD) or Light Emitting Diode (LED) technology. Processor(s) 702 uses any processor technology, including but not limited to graphics processors and multi-core processors. Input device 704 includes any known input device technology, including but not limited to a keyboard (including a virtual keyboard), mouse, track ball, and touch-sensitive pad or display. Bus 712 includes any internal or external bus technology, including but not limited to ISA, EISA, PCI, PCI Express, USB, Serial ATA or FireWire. Computer-readable medium 710 includes any non-transitory computer readable medium that provides instructions to processor(s) 702 for execution, including without limitation, non-volatile storage media (e.g., optical disks, magnetic disks, flash drives, etc.), or volatile media (e.g., SDRAM, ROM, etc.).

Computer-readable medium 710 includes various instructions 714 for implementing an operating system (e.g., Mac OS®, Windows®, Linux). The operating system may be multi-user, multiprocessing, multitasking, multithreading, real-time, and the like. The operating system performs basic tasks, including but not limited to: recognizing input from input device 704; sending output to display device 706; keeping track of files and directories on computer-readable medium 710; controlling peripheral devices (e.g., disk drives, printers, etc.) which can be controlled directly or through an I/O controller; and managing traffic on bus 712. Network communications instructions 716 establish and maintain network connections (e.g., software for implementing communication protocols, such as TCP/IP, HTTP, Ethernet, telephony, etc.).

Application(s) 718 may comprise an application that uses or implements the processes described herein and/or other processes. The processes may also be implemented in the operating system.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a user computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include user devices and servers. A user device and server may generally be remote from each other and may typically interact through a network. The relationship of user device and server may arise by virtue of computer programs running on the respective computers and having a relationship with each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method performed by a processor, the method comprising:
determining or receiving a desired K-value indicating a level of anonymity for entries in a data record in a format of a table stored on a database server, the data record requested by an end user computer of a plurality of end user computers;
determining a masking function for masking the entries in the data record; and
storing a copy of the data record in a backup data record on the database server, the backup data record accessible to a data provider for anonymity processing;
receiving a request from the end user requesting at least a portion of the data record;
in response to the request, applying the masking function to the entries in the data record to modify the data record to produce a masked data record having the desired K-value, the applying of the masking function comprising:
applying the masking function per row or per column to the entries in the data record to produce masked columns or masked rows,
computing a respective anonymity score for each of the masked columns or the masked rows,
selecting one of the masked columns or the masked rows having a highest respective anonymity score,
adding the selected one of the masked columns or the masked rows having the highest respective anonymity score to the data record while maintaining unselected columns or rows in the data record, and
repeatedly applying the masking function to the data record including to the masked columns or the masked rows until the data record achieves the desired K-value, and setting the data record as the masked data record;
storing, by the database server, the masked data record on the database server; and
when the masked data record achieves the desired K-value, the database server provides the masked data record for display on a graphical user interface (GUI) of the end user computer while maintaining the backup data record in the database server accessible to the data provider for anonymity processing, the GUI displaying and providing the entries in the masked data record as searchable entries, by the end user, and the database server preventing the GUI from accessing and displaying the entries in the backup data record to the end user.

2. The method of claim 1, wherein the K-value ensures each of the entries has at least K−1 identical entries in the data record.

3. The method of claim 1, further comprising:
analyzing the entries in the data record to determine entries that are identifiers, and to determine entries that are non-identifiers; and
applying the masking function to the entries that are identifiers, and maintaining the entries that are non-identifiers.

4. The method of claim 1, further comprising:
applying the masking function to suppress or generalize values of the entries in the data record.

5. The method of claim 1, further comprising:
classifying the entries as either categorical data, textual data or numerical data; and
applying the masking function to modify the entries differently depending on the classification.

6. The method of claim 5, further comprising:
modifying the categorical entries by clustering;
modifying the textual entries by character subtraction; and
modifying the numerical data by grouping.

7. The method of claim 1, further comprising:
determining the K-value based on at least one of importance of data, use of the data, sensitivity of the data or risk of attack on the data.

8. The method of claim 1, further comprising:
a) computing contributions to the K-value achieved by applying the masking function to a plurality of categories of the entries in the data record;
b) choosing one of the plurality of categories based on the contributions to the K-value;
c) applying the masking function to the chosen one of the plurality of categories; and
repeating steps (b) and (c) for remaining ones ene of the plurality of categories until the K-value for the data record is achieved.

9. The method of claim 8, further comprising:
choosing, in step (b), the one of the plurality of categories according to a greedy solution that selects the one of the plurality of categories that results in the greatest contribution to the K-value.

10. The method of claim 8, further comprising:
choosing, in step (b), the one of the plurality of categories based on at least one of importance of data, use of the data, sensitivity of the data or risk of attack on the data.

11. A system comprising:
a non-transitory storage medium storing computer program instructions; and
one or more processors configured to execute the computer program instructions to cause operations comprising:
determining or receiving a desired K-value indicating a level of anonymity for entries in a data record in a format of a table stored on a database server, the data record requested by an end user computer of a plurality of end user computers;
determining a masking function for masking the entries in the data record;
storing a copy of the data record in a backup data record on the database server, the backup data record accessible to a data provider for anonymity processing;
receiving a request from the end user requesting at least a portion of the data record;
in response to the request, applying the masking function to the entries in the data record to modify the data record to produce a masked data record having the desired K-value, the applying of the masking function comprising:
applying the masking function per row or per column to the entries in the data record to produce masked columns or masked rows,
computing a respective anonymity score for each of the masked columns or the masked rows,
selecting one of the masked columns or the masked rows having a highest respective anonymity score,
adding the selected one of the masked columns or the masked rows having the highest respective anonymity score to the data record while maintaining unselected columns or rows in the data record, and
repeatedly applying the masking function to the data record including to the masked columns or the masked rows until the data record achieves the desired K-value, and setting the data record as the masked data record;
storing the masked data record on the database server; and
when the masked data record achieves the desired K-value, the database server providing the masked data record for display on a graphical user interface (GUI) of the end user computer while maintaining the backup data record in the database server accessible to the data provider for anonymity processing, the GUI displaying and providing the entries in the masked data record as searchable entries by the end user, and the database server preventing the GUI from accessing and displaying the entries in the backup data record to the end user.

12. The system of claim 11, wherein the K-value ensures that each of the entries has at least K−1 identical entries in the data record.

13. The system of claim 11, wherein the operations further comprise:
analyzing the entries in the data record to determine entries that are identifiers, and to determine entries that are non-identifiers; and
applying the masking function to the entries that are identifiers, and maintaining the entries that are non-identifiers.

14. The system of claim 11, wherein the operations further comprise:
applying the masking function to suppress or generalize values of the entries in the data record.

15. The system of claim 11, wherein the operations further comprise:
classifying the entries as either categorical data, textual data or numerical data; and
applying the masking function to modify the entries differently depending on the classification.

16. The system of claim 15, wherein the operations further comprise:
modifying the categorical entries by clustering;
modifying the textual entries by character subtraction; and
modifying the numerical data by grouping.

17. The system of claim 11, wherein the operations further comprise:
determining the K-value based on at least one of importance of the data, use of the data, sensitivity of the data or risk of attack on the data.

18. The system of claim 11, wherein the operations further comprise:
a) computing contributions to the K-value achieved by applying the masking function to a plurality of categories of the entries in the data record;
b) choosing one of the plurality of categories based on the contributions to the K-value;
c) applying the masking function to the chosen one of the plurality of categories; and
repeating steps (b) and (c) for remaining ones ene of the plurality of categories until the K-value for the data record is achieved.

19. The system of claim 18, wherein the operations further comprise:
choosing, in step (b), the one of the plurality of categories according to a greedy solution that selects the one of the plurality of categories that results in a greatest contribution to the K-value.

20. The system of claim 18, wherein the operations further comprise:
choosing, in step (b), the one of the plurality of categories based on at least one of importance of data, use of the data, sensitivity of the data or risk of attack on the data.
